(19) United States
(12) Patent Application Publication
(10) Pub. No.: US 2021/0345644 A1
(43) Pub. Date: Nov. 11, 2021

(54) Pet Food Formulation

(71) Applicant: Tom Radcliffe, Carmel Valley, CA (US)

(72) Inventor: Tom Radcliffe, Carmel Valley, CA (US)

(21) Appl. No.: 17/379,774

(22) Filed: Jul. 19, 2021

Related U.S. Application Data
(63) Continuation of application No. 16/282,731, filed on Feb. 22, 2019.

(51) Int. Cl. A23K 10/20; A23K 20/174; A23K 20/163; A23K 10/30; A23K 50/40; A23K 20/26; A23K 20/105; A23K 20/20; A23K 20/22

(52) U.S. Cl. CPC A23K 10/20; A23K 20/174; A23K 20/163; A23K 10/30; A23K 20/22; A23K 20/26; A23K 20/105; A23K 20/30; A23K 50/40

(57) ABSTRACT

A prepared cat food has chicken meat and mouse meat, the chicken meat in at least ten times the mass of the mouse meat, vitamin supplements, and one or more mineral ingredients. The mouse meat in a substantially lesser mass than the chicken meat induces the cat to consume a greater volume of the prepared food than the cat would consume without the presence of the mouse meat, thereby supplying the cat with a greater volume of chicken meat, vitamin supplements and mineral ingredients than cat would consume in a product without the mouse meat.

### CROSS-REFERENCE TO RELATED DOCUMENTS

The present application is a continuation of co-pending application Ser. No. 16/282,731, filed on Feb. 22, 2019, and all disclosure of the parent application is incorporated herein at least by reference.

### BACKGROUND OF THE INVENTION

### 1. Field of the Invention

The present invention is in the technical field of canned food formulated for domestic pets.

### 2. Description of Related Art

A very large number of formulations for pet food are known in the art, and a similarly large number of pet food products are produced and sold to owners of pets and institutions where domestic animals may be housed and fed.

It is known to the inventor, who is a person of skill in the art of developing and selling food for domestic animals, including canned food, that pet owners are typically concerned about the appetite of individual ones of their pets, and are typically interested in ingredients, flavor, odor, consistency and cost of pet food products. Sales of pet foods are, of course, to pet owners, and to administrators of institutions where domestic animals may be housed, and not to the animals that may, or may not, consume the various products. Advertising to pet owners and administrators of such institutions is often keyed to characteristics of the actual pet food product, such as potentially flavor and odor, although the pet owners and administrators likely do not consume the stuff.

Still, there is room for improvement in the industry to provide new products that may be unique and unusual and may feature unusual ingredients not before advertised as present in products for certain domestic animals.

### BRIEF SUMMARY OF THE INVENTION

In one embodiment of the invention a prepared cat food is provided, comprising chicken meat and mouse meat, the chicken meat in at least ten times the mass of the mouse meat, vitamin supplements, and one or more mineral ingredients. The mouse meat in a substantially lesser mass than the chicken meat induces the cat to consume a greater volume of the prepared food than the cat would consume without the presence of the mouse meat, thereby supplying the cat with a greater volume of chicken meat, vitamin supplements and mineral ingredients than cat would consume in a product without the mouse meat.

In one embodiment the mouse meat is no more than three percent of the total mass of meat ingredients. Also, in one embodiment the mouse meat is in a form of whole, young pinky mice. In one embodiment the prepared cat food further comprises one or more of Cat Grass, Potassium Chloride, Dicalcium Phosphate, Brewers Dried Yeast, and Taurine.

In one embodiment the vitamin supplements comprise one or more of Vitamin E Supplement, Niacin Supplement, L-Ascorbyl-2-Polyphosphate as a source of Vitamin C] Thiamine Mononitrate as a source Of Vitamin B1, Calcium Pantothenate, Vitamin A Supplement, Pyridoxine Hydrochloride as a source Of Vitamin B6, Riboflavin Supplement as a source Of Vitamin B2, Folic Acid, and Biotin as a Vitamin D3 Supplement. Also, in one embodiment the mineral ingredients comprise one or more of Zinc Sulfate, Iron Sulfate, Copper Sulfate, Manganese Sulfate, Sodium Selenite, and Potassium Iodide.

In another aspect of the invention a prepared cat food is provided, comprising rabbit meat and mouse meat, the rabbit meat in at least ten times the mass of the mouse meat, vitamin supplements, and one or more mineral ingredients. The rabbit meat in a substantially lesser mass than the chicken meat induces the cat to consume a greater volume of the prepared food than the cat would consume without the presence of the rabbit meat, thereby supplying the cat with a greater volume of chicken meat, vitamin supplements and mineral ingredients than cat would consume in a product without the rabbit meat.

In one embodiment the rabbit meat is no more than three percent of the total mass of meat ingredients. Also, in one embodiment the prepared cat food further comprises mouse meat. Also, in one embodiment the prepared cat food further comprises one or more of Cat Grass, Potassium Chloride, Dicalcium Phosphate, Brewers Dried Yeast, and Taurine. Also, in one embodiment the vitamin supplements comprise one or more of Vitamin E Supplement, Niacin Supplement, L-Ascorbyl-2-Polyphosphate as a source of Vitamin C] Thiamine Mononitrate as a source Of Vitamin B1, Calcium Pantothenate, Vitamin A Supplement, Pyridoxine Hydrochloride as a source Of Vitamin B6, Riboflavin Supplement as a source Of Vitamin B2, Folic Acid, and Biotin as a Vitamin D3 Supplement. In one embodiment the mineral ingredients comprise one or more of Zinc Sulfate, Iron Sulfate, Copper Sulfate, Manganese Sulfate, Sodium Selenite, and Potassium Iodide. In one embodiment the prepared cat food further comprises slippery elm oil as an ingredient, for preventing and treating hairballs in cats.

### BRIEF DESCRIPTION OF THE SEVERAL VIEWS OF THE DRAWINGS

FIG. 1 is a flow chart illustrating a process of production and packaging of a cat food in an embodiment of the present invention.

FIG. 2A is a first portion of a label for a can in an embodiment of the invention.

FIG. 2B is another portion of the label of FIG. 2A.

FIG. 3 is a flow chart illustrating a process of production and packaging of a dog food product in an embodiment of the invention.

### DETAILED DESCRIPTION OF THE INVENTION

In the initial process of determining ingredients for food for a domesticated animal, such as a domestic cat, for example, the inventor has researched to some extent the natural food habits of cats of various sorts and in various geographic circumstances. There are, of course, many sorts of cats, large and small. Some are domestic as pets, some may be feral, and some may be completely wild, having been born in the wild and having little or no contact with humans.

The inventor believes it is reasonable to assume that there are still many similarities between all cats in the genus, and some of the similarities may have to do with food preferences.

The inventor, in considering food preferences of cats in the wild is aware that the preferences may be essentially opportunistic. A wild cat may hunt and consume mice, not because the cat prefers mice as opposed to squirrels, for example, but because there may be a lot more mice in the hunting area than there are squirrels, and the mice may be a lot easier to catch.

Still over many generations the original opportunistic circumstances may translate to biological preferences. The inventor notes, for example, that a domestic cat is quite sensitive to the odor of live mice, and in the presence of mice in the house, by odor rather than sight, the domestic cat will go into stalking and hunting mode.

It may also be that over many generations the dietary habits of wild and feral cats have become biologically institutionalized in domestic cats. The inventor has noted as well that domestic cats, even if well fed and nourished, will still often hunt and consume mice.

Having said all of the above, the inventor has searched available pet food vendors unsuccessfully for actual cat food having mice, or mouse meat or parts as an ingredient. It is most likely, but not certain, that mouse meat has no exceptional nutritional value over, for example, chicken, in a cat food product. Still, the inventor believes that the flavor or the odor, or both, of a cat food product including some portion, even a small portion, of mouse meat might well lead domestic cats to have a healthier than normal affinity for the product, which may enhance the cat's nutritional level simply by leading the cat to consume more of the product that has other nutritional ingredients.

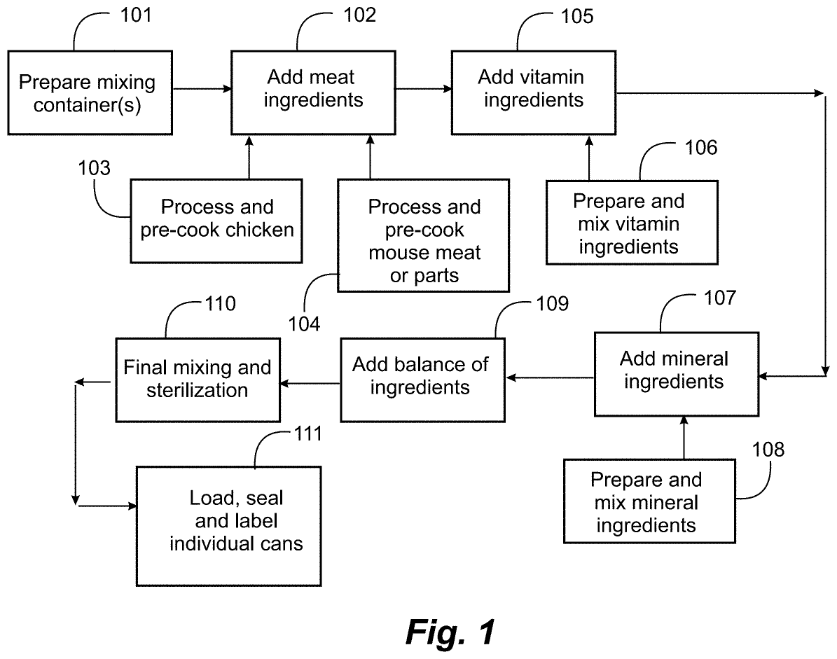

FIG. 1 is a flow chart illustrating a process of production and packaging of a pet food for domestic cats in an embodiment of the present invention. At step 101 mixing containers are cleaned and sterilized to be ready for mixing and processing ingredients. At step 103 chicken meat is prepared. The chicken meat may be in any one of several forms from freshly-killed chickens to commercially available chicken products. The chicken may be chopped or shredded and may be mixed with broth to a pre-defined consistency.

At step 104 mouse meat may be prepared. The mouse meat may be in the form of whole young pinky mice, which are commercially available. In some embodiments the mouse meat may shredded or chopped. At step 102 the meat ingredients are added to the mixing containers.

At step 106 vitamin ingredients may be pre-prepared and premixed. The vitamin mixture may comprise any one or more of Vitamin E Supplement, Niacin Supplement, L-Ascorbyl-2-Polyphosphate [Source of Vitamin C], Thiamine Mononitrate [Source Of Vitamin B1], Calcium Pantothenate, Vitamin A Supplement, Pyridoxine Hydrochloride [Source Of Vitamin B6], Riboflavin Supplement [Source Of Vitamin B2], Folic Acid, (Vitamin B12 Supplement), and Biotin (Vitamin D3 Supplement).

The relative proportions of ingredients may vary widely in different alternative embodiments. In terms of the meat ingredients, in one embodiment the proportions are 97% chicken and 3% mouse meat. These proportions may vary somewhat in different circumstances, but the percentage of mouse meat will always be less than 10%, and seldom over 5%. The percentage of mouse meat to chicken may in some embodiments be as low as 1%.

The premixed vitamins are added to the mixing containers at step 105. Mineral ingredients are prepared and mixed at step 108. These may be any one or a mixture of Zinc Sulfate, Iron Sulfate, Copper Sulfate, Manganese Sulfate, Sodium Selenite, and Potassium Iodide. The mineral ingredients are added to the developing recipe at step 107.

There are several ingredients in this embodiment that are not meat, vitamins or minerals. These are one or more of Cat Grass, Potassium Chloride, Dicalcium Phosphate, Brewers Dried Yeast, and Taurine. One or more of these ingredients are added at step 109. At step 110 final mixing and cooking to kill pathogens is accomplished. At step 111 individual cans are loaded, sealed and labeled. Then cans may be boxed and packed for shipment.

The generalized process illustrated by the flow chart of FIG. 1 is illustrative of preparation of several different products distinguished by different ingredients, the products intended by the inventor for cats of different sorts. The ingredients described above provide a cat food product distinguished by mouse meat, intended for domestic cats that are either themselves what the inventor terms field hunters, or are closely related to wild cats that are field hunters. Field hunters focus on field mice. Another cat food product is provided for what the inventor terms brush hunters.

A primary difference is the product for brush hunters may have rabbit meat instead of, or as well as chicken. Mouse meat is still an ingredient in the proportions described above for the product for field hunters.

Yet another product is provided for cats that may be hunters in regions populated by rats of various sorts. This product is distinguished by rat meat instead of mouse meat.

Another cat food product is provided for use as a cat food to aid in preventing cat urine crystals. This product is distinguished by D-Mannose as a minor ingredient. D-mannose is a sugar monomer of the aldohexose series of carbohydrates. Mannose is a C-2 epimer of glucose. Mannose is important in human metabolism, especially in the glycosylation of certain proteins.

Yet another cat food product is distinguished by slippery elm oil as a minor ingredient, for prevention and treatment of hairballs in cats.

Further to the above, other products may be distinguished by one or more of quail meat, and insects, such as grasshoppers and crickets, either whole or chopped or shredded.

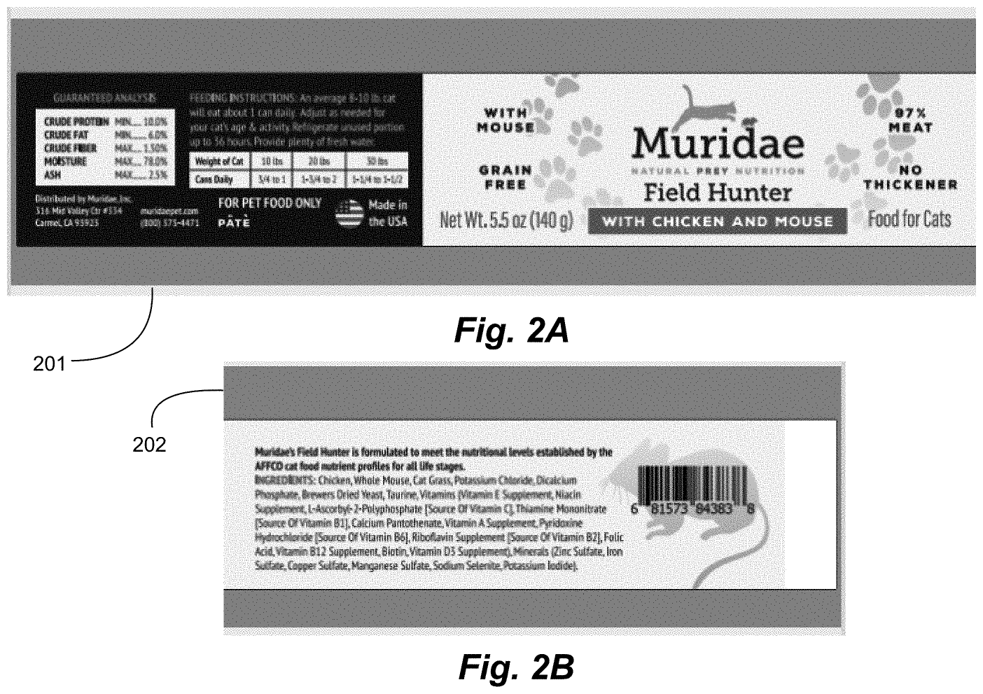

FIGS. 2A and 2B illustrate a label intended for cans for the Field Hunter product described above as an embodiment. The label is shown in two separate portions to enhance readability. In use the portions are joined end-to-end to circle a round metal can. The portion shown in FIG. 2A shows a main name and features annotated graphic, company contact information, and feeding instructions. The portion shown in FIG. 2B adds detailed ingredients.

Following is a list of ingredients that the inventor considers to be viable candidates for unique ingredients in pet food, separated into categories:

### Rodents

Mouse, Dormouse, Rat, Possum, Squirrel, Ground Squirrel, Chipmunks, Woodchucks, Muskrats, Lemmings, Beavers, Raccoons, Mole, Marmot, Gopher, Vole, Woodrat

### Animals

Moose, Elk

### Birds

Geese, Frozen Chicken Chicks

### Insects

Cricket, Mealworms, Kingworms, Waxworms, Black Soldier Fly Larvae, Grasshopper Earthworms

### Plants

Grass (Wheat grass, orchard grass, oat grass), Catnip

### Berries

Olallieberry, Marionberry, Boysenberry, Blackberry, Loganberry, Dewberry, Thimbleberries, Raspberries, Elderberries

### Lizards

Lizards

### Supplements (Plant Extracts)

Slippery Elm (for hairball), D-Manos (for urinary crystals), Boswellia (Inflammation), Devils Claw (Inflammation), Coriolus Versicolor Mushroom, Agaricus Blazei Mushroom, Reishi Mushroom, Shiitake Mushroom, Maitake Mushroom, Cordyceps Mushroom, King Trumpet Mushroom, Lion's Mane Mushroom, Turkey Tail Mushroom

In various embodiments of the invention any one of the above ingredients may be incorporated, and any combination may be incorporated.

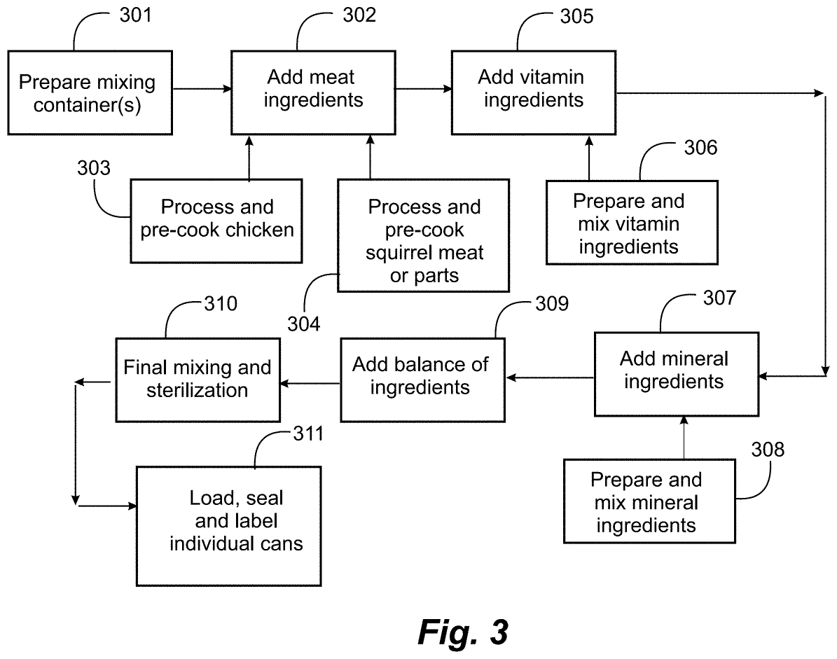

In an alternative embodiment of the invention a pet food intended for dogs is provided. In this unique product the unusual ingredient is squirrel meat, which, although stated as squirrel, may be any one of several kinds of squirrels, including ground squirrels. FIG. 3 is a flow chart illustrating steps in preparation of the dog food product. At step 301 mixing containers are cleaned and sterilized to be ready for mixing and processing ingredients. At step 303 chicken meat is prepared. The chicken meat may be in any one of several forms from freshly-killed chickens to commercially available chicken products. The chicken may be chopped or shredded and may be mixed with broth to a pre-defined consistency.

At step 304 squirrel meat may be prepared. The squirrel meat will typically be chopped or ground and may be precooked. At step 302 the meat ingredients are added to the mixing containers.

At step 306 vitamin ingredients may be pre-prepared and premixed. The vitamin mixture may comprise any one or more of Vitamin E Supplement, Niacin Supplement, L-Ascorbyl-2-Polyphosphate [Source of Vitamin C], Thiamine Mononitrate [Source Of Vitamin B1], Calcium Pantothenate, Vitamin A Supplement, Pyridoxine Hydrochloride [Source Of Vitamin B6], Riboflavin Supplement [Source Of Vitamin B2], Folic Acid, (Vitamin B12 Supplement), and Biotin (Vitamin D3 Supplement).

The relative proportions of ingredients may vary widely in different alternative embodiments. In terms of the meat ingredients, in one embodiment the proportions are 97% chicken and 3% squirrel meat. These proportions may vary somewhat in different circumstances, but the percentage of squirrel meat will always be less than 10%, and seldom over 5%. The percentage of squirrel meat to chicken may in some embodiments be as low as 1%.

The premixed vitamins are added to the mixing containers at step 305. Mineral ingredients are prepared and mixed at step 308. These may be any one or a mixture of Zinc Sulfate, Iron Sulfate, Copper Sulfate, Manganese Sulfate, Sodium Selenite, and Potassium Iodide. The mineral ingredients are added to the developing recipe at step 307.

There are several ingredients in this embodiment that are not meat, vitamins or minerals. These are one or more of, Potassium Chloride, Dicalcium Phosphate, Brewers Dried Yeast, and Taurine. One or more of these ingredients are added at step 309. At step 310 final mixing and cooking to kill pathogens is accomplished. At step 311 individual cans are loaded, sealed and labeled. Then cans may be boxed and packed for shipment.

It will be clear to the skilled person that there are many alterations that may be made in embodiments of the invention beyond the specific description above, within the scope of the invention. Specific ingredients and proportions of same may depend on

I claim:

1. Prepared cat food, comprising:
chicken meat and mouse meat, the chicken meat in at least ten times the mass of the mouse meat;
vitamin supplements; and
one or more mineral ingredients;
wherein the mouse meat in a substantially lesser mass than the chicken meat induces the cat to consume a greater volume of the prepared food than the cat would consume without the presence of the mouse meat, thereby supplying the cat with a greater volume of chicken meat, vitamin supplements and mineral ingredients than cat would consume in a product without the mouse meat.

2. The prepared cat food of claim 1 wherein the mouse meat is no more than three percent of the total mass of meat ingredients.

3. The prepared cat food of claim 1 wherein the mouse meat is in a form of whole, young pinky mice.

4. The prepared cat food of claim 1 further comprising one or more of Cat Grass, Potassium Chloride, Dicalcium Phosphate, Brewers Dried Yeast, and Taurine.

5. The prepared cat food of claim 1 wherein the vitamin supplements comprise one or more of Vitamin E Supplement, Niacin Supplement, L-Ascorbyl-2-Polyphosphate as a source of Vitamin C] Thiamine Mononitrate as a source Of Vitamin B1, Calcium Pantothenate, Vitamin A Supplement, Pyridoxine Hydrochloride as a source Of Vitamin B6, Riboflavin Supplement as a source Of Vitamin B2, Folic Acid, and Biotin as a Vitamin D3 Supplement.

6. The prepared cat food of claim 1 wherein the mineral ingredients comprise one or more of Zinc Sulfate, Iron Sulfate, Copper Sulfate, Manganese Sulfate, Sodium Selenite, and Potassium Iodide.

7. Prepared cat food, comprising:
rabbit meat and mouse meat, the rabbit meat in at least ten times the mass of the mouse meat;
vitamin supplements; and
one or more mineral ingredients;
wherein the rabbit meat in a substantially lesser mass than the chicken meat induces the cat to consume a greater volume of the prepared food than the cat would consume without the presence of the rabbit meat, thereby supplying the cat with a greater volume of chicken meat, vitamin supplements and mineral ingredients than cat would consume in a product without the rabbit meat.

8. The prepared cat food of claim 7 wherein the rabbit meat is no more than three percent of the total mass of meat ingredients.

9. The prepared cat food of claim 8 further comprising mouse meat.

10. The prepared cat food of claim 8 further comprising one or more of Cat Grass, Potassium Chloride, Dicalcium Phosphate, Brewers Dried Yeast, and Taurine.

11. The prepared cat food of claim 8 wherein the vitamin supplements comprise one or more of Vitamin E Supplement, Niacin Supplement, L-Ascorbyl-2-Polyphosphate as a source of Vitamin C] Thiamine Mononitrate as a source Of Vitamin B1, Calcium Pantothenate, Vitamin A Supplement, Pyridoxine Hydrochloride as a source Of Vitamin B6, Riboflavin Supplement as a source Of Vitamin B2, Folic Acid, and Biotin as a Vitamin D3 Supplement.

12. The prepared cat food of claim 8 wherein the mineral ingredients comprise one or more of Zinc Sulfate, Iron Sulfate, Copper Sulfate, Manganese Sulfate, Sodium Selenite, and Potassium Iodide.

13. The prepared cat food of claim 1 further comprising D-Mannose as an ingredient, for preventing and treating formation of cat urine crystals.

14. The prepared cat food of claim 7 further comprising D-Mannose as an ingredient, for preventing and treating formation of cat urine crystals.

15. The prepared cat food of claim 1 further comprising slippery elm oil as an ingredient, for preventing and treating hairballs in cats.

16. The prepared cat food of claim 7 further comprising slippery elm oil as an ingredient, for preventing and treating hairballs in cats.
